(19) United States
(12) Patent Application Publication
(10) Pub. No.: US 2005/0078873 A1
(43) Pub. Date: Apr. 14, 2005

(54) Movement detection and estimation in wavelet compressed video

(76) Inventors: Ahmet Enis Cetin, Ankara (TR); Mehmet Bilgay Akhan, Camberley (GB); Behcet Ugur Toreyin, Ankara (TR); Anil Aksay, Ankara (TR)

Correspondence Address: SAWYER LAW GROUP LLP, P.O. Box 51418, Palo Alto, CA, 94303, US

(21) Appl. No.: 10/768,606

(22) Filed: Jan. 29, 2004

Related U.S. Application Data
(60) Provisional application No. 60/444,002, filed on Jan. 31, 2003.

(51) Int. Cl. G06K 9/36; G06K 9/46; H04N 7/12; H04B 1/66

(52) U.S. Cl. 382/236; 382/240; 375/240.12; 375/240.19

(57) ABSTRACT

A method and system for moving object and region detection in video compressed using a wavelet transform is disclosed. A plurality of images are inputted to the system in wavelet compressed format in time series. In a first aspect, a method and system determines the motion by comparing the wavelet transform of the current image and the wavelet transform of the previous image of the video. Difference between the wavelet coefficients of the current and previous images indicate motion. Moving regions in the video can be estimated by determining the wavelet coefficients of the current image frame, which are different from the wavelet coefficients of the previous image frame. The method and system does not include performing an inverse wavelet transform on the wavelet transformed image. This leads to a computationally efficient method and a system compared to the existing motion estimation methods.

### FIELD OF THE INVENTION

The present invention relates to techniques for the detection of moving objects and regions, and their motion in digital video, which is compressed by a wavelet transform based video encoding system.

### BACKGROUND OF THE INVENTION

1. Description of Prior Art

In U.S. Pat. No. 5,321,776, class 382/240 filed on 26 Feb. 1992, Shapiro describes a method where wavelet transformed data is compressed using successive approximation quantization. Coefficients are then sorted numerically without ordering them into wavelet quarter blocks. This way Shapiro generates a data stream that progressively encodes the data. In other words, data becomes more accurate as progressive encoding makes progress. Progressively coded data stream can be truncated at any point. Coarser coefficients offer an approximation to the original image. Shapiro's method is an example of image coding using wavelet transform. A sequence of images forming a video can be compressed one by one using Shapiro's method.

In U.S. Pat. No. 5,495,292, class 375/240.02 filed on Feb. 27, 1996, Zhang, et al. describe a video coding scheme in which a plurality of images forming the video are compressed using a wavelet transform. The method is based on wavelet representation performing motion compensation in the wavelet domain rather than spatial domain.

U.S. Pat. Nos. 5,321,776, and 5,495,292 are examples of image and video coding methods using wavelet transform. In addition, the so-called JPEG2000 image compression standard (ISO/IEC 15444-1:2000) is also based on wavelet transform. A video consisting of a plurality of images can be encoded using JPEG2000 standard by compressing each image of the video using JPEG2000 standard. Since there are many methods representing video in wavelet transform domain it is important to carry out moving object and motion detection in compressed data domain.

In German patent DE20001050083, IPC Class G06K9/00, filed on Oct. 10, 2000, Plasberg describes an apparatus and a method for the detection of an object moving in the monitored region of a camera, wherein measured values are compared with reference values and an object detection reaction is triggered when the measured value deviates in a predetermined manner from the reference value. This method is based on comparing the actual pixel values of images forming the video. Plasberg makes no attempt to use compressed images or video stream. In many real-time applications, it is not possible to use uncompressed video due to available processor power limitations.

In U.S. Pat. No. 6,025,879, class 375,240.24, filed on 15 Feb. 2000, Yoneyama et.al, describes a system for detecting a moving object in a moving picture, which can detect moving objects in block based compression schemes without completely decoding the compressed moving picture data. In block based compression schemes the picture is divided into small blocks and they are compressed separately using the discrete cosine transform or a similar transform. The method is based on the so-called motion vectors characterizing the motions of blocks forming each image. Motion vectors are determined from the actual pixel values of images forming the video. Yoneyama's approach restricts the accuracy of motion calculation to the pre-defined blocks and makes no attempt to reduce the amount of processing required by ignoring the non-moving background parts. In addition, this method does not take advantage of the fact that wavelet transform coefficients contain spatial information about the original image. Therefore it cannot be used in video compressed using a wavelet transform.

In U.S. Pat. No. 5,991,428, class 382 107 23, Nov. 1999, Taniguchi et.al, describe a moving object detection apparatus including a movable input section to input a plurality of images in a time series, in which a background area and a moving object are included. A calculation section divides each input image by unit of predetermined area, and calculates the moving vector between two images in a time series and a corresponding confidence value of the moving vector by unit of the predetermined area. A background area detection section detects a group of the predetermined areas, each of which moves almost equally as the background area from the input image according to the moving vector and the confidence value by unit of the predetermined area. A moving area detection section detects the area other than the background area as the moving area from the input image according to the moving vector of the background area. This method is also based on comparing the actual pixel values of images forming the video and there is no attempt to use compressed images or video stream for motion detection.

In the survey article by Wang, et. al., published in the Internet web page: http://vision.poly.edu:8080/˜avetro/pub.html, a motion estimation and detection methods in compressed domain are reviewed. All of the methods are developed for detecting motion in Discrete Cosine Transform (DCT) domain. DCT coefficients neither carry time nor space information. In DCT based image and video coding, DCT of image blocks are computed and motion of these blocks are estimated. Therefore these methods restrict the accuracy of motion calculation to the pre-defined blocks. Furthermore, these methods do not take advantage of the fact that wavelet transform coefficients contain spatial information about the original image. Therefore, they cannot be used in video compressed using a wavelet transform.

Accordingly, what is needed is a system and method improving the accuracy of motion calculation. The method and system should be easily cost effective and adaptable to existing systems. The present invention addresses such a need.

### SUMMARY OF THE INVENTION

A method and system for moving object and region detection in digital video compressed using a wavelet transform is disclosed. In a first aspect, a method and system determines the motion by comparing the wavelet transform of the current image and the wavelet transform of the previous image of the video. A difference between the wavelet coefficients of the current and previous images indicate motion. By determining the wavelet coefficients of the current image frame which are different from the wavelet coefficients of the previous image frame moving regions in the video can be estimated. The method and system does not include performing an inverse wavelet transform on the wavelet transformed image. This leads to a computationally efficient method and a system compared to the existing motion estimation methods.

In a second aspect, a method and system estimates a wavelet transform of the background scene from the wavelet transforms of the past image frames of the video. The wavelet transform of the current image is compared with the WT of the background and locations of moving objects are determined from the difference.

In a third aspect, a method and system for determining the size and location of moving objects and regions in video is disclosed. The method and system comprise estimating the location of moving objects and regions from the wavelet coefficients of the current image which differ from the estimated background wavelet coefficients. Wavelet coefficients of an image carry both frequency and space information. Each wavelet coefficient is produced by a certain image region whose size is defined by the extent of wavelet filter coefficients. A difference between a wavelet coefficient of the current image and the wavelet coefficient of the background indicates a motion in the corresponding region of the current image. In this way size and location of moving regions in the current image of the video is determined by taking the union of all regions whose wavelet coefficients change temporally.

The present invention provides several methods and apparatus for detecting moving objects and regions in video encoded using wavelet transform without performing data decoding.

### BRIEF DESCRIPTION OF THE DRAWINGS

FIG. 1 is a diagrammatic illustration of the transformation of an original image into a one-level wavelet transformed image.

FIG. 2 is a diagrammatic illustration of the transformation of a portion of an original image into three levels using a wavelet transform.

FIG. 3 is a block diagram illustrating the present invention for detecting moving regions in an image sequence forming a video by comparing the wavelet transform of the current image with the wavelet transform of the previous image of the video.

FIG. 4 is a block diagram illustrating the present invention for detecting moving regions in an image sequence forming a video by comparing the wavelet transform of the current image with the estimated wavelet transform of the background.

### DETAILED DESCRIPTION

The present invention relates to techniques for the detection of moving objects and regions, and their motion in digital video, which is compressed by a wavelet transform based video encoding system. The method operates on compressed data, compressed using a wavelet transformation technique. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

Several embodiments and examples of the present invention are described below. While particular applications and methods are explained, it should be understood that the present invention can be used in a wide variety of other applications and with other techniques within the scope of the present invention.

In a system and method in accordance with the present invention the video data is compressed using a wavelet transform. Wavelet transforms have substantial advantages over conventional Fourier transforms for analyzing nonlinear and non-stationary time series. This is principally because a wavelet transform contains both time and frequency information whereas Fourier Transform contains only frequency information of the original signal. Wavelet transforms are used in a variety of applications, some of which include data smoothing, data compression, and image reconstruction, among many others.

Wavelet transforms such as the Discrete Wavelet Transform (DWT) can process a signal to provide discrete coefficients, and many of these coefficients can be discarded to greatly reduce the amount of information needed to describe the signal. One area that has benefited the most from this particular property of the wavelet transforms is image and video processing. The DWT can be used to reduce the size of an image without losing much of the resolution. For example, for a given image, the DWT of each row can be computed, and all the values in the DWT that are less then a certain threshold can be discarded. Only those DWT coefficients that are above the threshold are saved for each row. When the original image is to be reconstructed, each row can be padded with as many zeros as the number of discarded coefficients, and the inverse Discrete Wavelet Transform (IDWT) can be used to reconstruct each row of the original image. Or, the image can be analyzed at different scales corresponding to various frequency bands, and the original image reconstructed by using only the coefficients that are of a particular band.

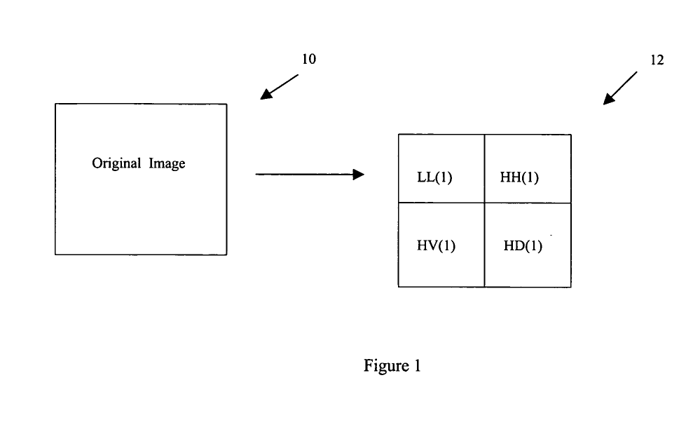

FIG. 1 illustrates the transformation of an original image 10 of the video into a one-level sub-sampled image 12. Wavelet transforms can decompose an original image into sub-images in various scales each sub-image representing a frequency subset of the original image. Wavelet transforms use a bank of filters processing the image pixels to decompose the original image into high- and low-frequency components. This operation can be successively applied to decompose the original image into a low-frequency, various medium-band frequency, and high-frequency components.

After each stage of filtering data can be sub-sampled without losing any information because of the special nature of the wavelet filters. One level of two-dimensional dyadic wavelet transform creates four sub-sampled separate quarters, each containing different sets of information about the image. It is conventional to name the top left quarter Low-Low (LL)—containing low frequency horizontal and low frequency vertical information; the top right quarter High-Horizontal (HH)—containing high frequency horizontal information; the bottom left quarter High-Vertical (HV)—containing high frequency vertical information; and the bottom right quarter High-Diagonal (HD)—containing high frequency diagonal information. The level of transform is denoted by a number suffix following the two-letter code. For example, LL(1) refers to the first level of transform and denotes the top left corner of the sub-sampled image 12 by a factor of two in both horizontal and vertical dimensions.

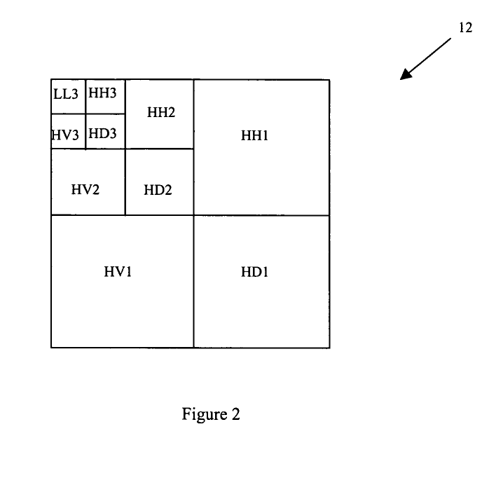

Typically, wavelet transforms are performed for more than one level. FIG. 2 illustrates further transforms that have been performed on the LL quarter of the sub-sampled image 12 to create additional sub-sampled images. The second transform performed on the LL(1) quarter produces four second level quarters within the LL(1) quarter which are similar to the first level quarters, where the second level quarters are labeled as LL(2) (not shown), HH(2), HD(2), and HV(2). A third transform performed on the LL(2) quarter produces four third level quarters labeled as LL(3), HH(3), HD(3), and HV(3). Additional transforms can be performed to create sub-sampled images at lower levels. A hierarchy of sub-sampled images from wavelet transforms, such as the three levels of transform shown in FIG. 2, is also known as a “wavelet transform tree.” A typical three scale discrete wavelet transform (DWT) of the image I is defined as WI={LL(3), HH(3), HD(3), HV(3),HH(2), HD(2), HV(2), HH(1), HD(1), HV(1)}. The DWT of the image I may be defined to contain LL(1) and LL(2) as well. In fact the so-called sub-band images LL(3), HH(3), HD(3), and HV(3) uniquely define the sub-band image LL(2), and LL(2), HH(2), HD(2), and HV(2) uniquely define the so-called low-low image LL(1).

In wavelet transform based image encoders many of the small valued wavelet coefficients are discarded to reduce the amount of data to be stored. When the original image is to be reconstructed the discarded coefficients are replaced with zeros. A video is composed of a series of still images (frames) that are displayed to the user one at a time at a specified rate. Video sequences can take up a lot of memory or storage space when stored, and therefore can be compressed so that they can be stored in smaller spaces. In video data compression, each image frame of the video can be compressed using a wavelet coder. In addition, some portions of image frames or entire frames can be discarded especially when an image frame is positioned between two other frames in which most of the features of these frames remain unchanged.

In a system and method in accordance with the present invention the video data is stored in wavelet domain. In the present invention the wavelet transform of the current image is compared with the wavelet transforms of the near future and past image frames to detect motion and moving regions in the current image without performing an inverse wavelet transform operation.

A typical video scene contains foreground and background objects. It is assumed that moving objects and regions are in the foreground of the scene. Therefore moving regions and objects can be detected by comparing the wavelet transforms of the current image with the wavelet transform of the background scene which can be estimated from the wavelet transforms of past images. If there is a significant temporal difference between the wavelet coefficients of the current frame and past frames then this means that there is motion in the video. If there is no motion then the wavelet transforms of the current image and the previous image ideally should be equal to each other.

The wavelet transform of the background scene can be estimated from the wavelet coefficients of past image frames, which do not change in time, whereas foreground objects and their wavelet coefficients change in time. Such wavelet coefficients belong to the background because the background of the scene is temporally stationary. Non-stationary wavelet coefficients over time correspond to the foreground of the scene and they contain motion information. If the viewing range of the camera is observed for some time then the wavelet transform of the entire background can be estimated because moving regions and objects occupy only some parts of the scene in a typical image of a video and they disappear over time.

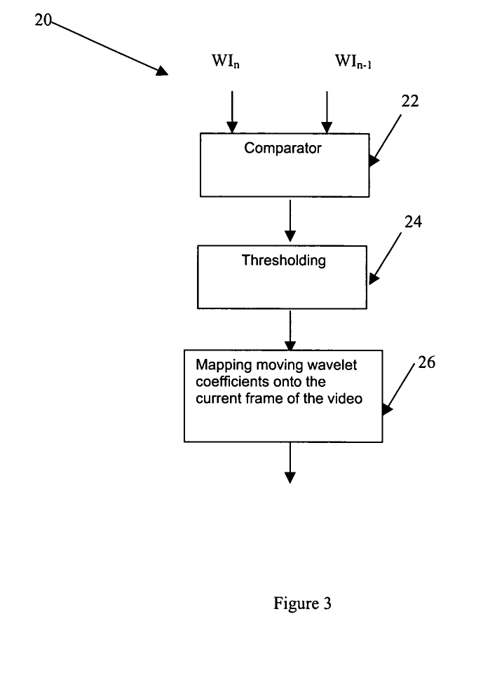

FIG. 3 is a block diagram 20 illustrating the present invention for detecting moving regions in a video consisting of a sequence of images. The block diagrams and flow diagrams illustrated herein are preferably implemented using software on any suitable general-purpose computer or the like, having microprocessor, memory, and appropriate peripherals, where the software is implemented with program instructions stored on a computer readable medium (memory device, CDROM or DVDROM, magnetic disk, etc.). The block diagrams and methods can alternatively be implemented using hardware (logic gates, etc.) or a combination of hardware and software.

The wavelet transforms WIₙ and WIₙ₋₁ of the current image frame In and previous image frame Iₙ₋₁ are input to a comparator 22. The comparator 22 may simply take the difference of WIₙ and WIₙ₋₁ to determine if there is a change in wavelet coefficients. In this operation the wavelet coefficients of the current image frame are subtracted from the corresponding wavelet coefficient of the previous frame. For example, the matrix of coefficients forming LL(3)ₙ is subtracted from the matrix of coefficients LL(3)ₙ₋₁. If there is no motion then the corresponding wavelet coefficients of the current and the previous image frames are ideally equal to each other. If an object or a region of the previous image frame moves to another location in the viewing range of the camera capturing the video or leaves the scene then some wavelet coefficients of the previous frame differ from wavelet coefficients of the current frame. By determining such wavelet coefficients an estimate of the location of the moving region can be determined. The output of the comparator 22 is processed by a thresholding block 24 as shown in FIG. 3. Each wavelet coefficient WIₙ (x,y) is compared with the corresponding wavelet coefficient WIₙ₋₁ (x,y) and those coefficients differing from previous ones indicate motion. In other words, if the absolute value of the difference is greater than a threshold
|WIₙ (x,y)−WIₙ₋₁(x,y)|>Threshold (Inequality 1)
then the (x,y)-th wavelet coefficient indicates that the region in the previous image frame producing this coefficient either moved to another location in the current image frame or it was occluded by a moving region. The value of the threshold can be determined experimentally. Different threshold values can be used in different sub-band images forming the DWT.

Once all the wavelet coefficients satisfying the above inequality are determined locations of corresponding regions on the original image are determined 26. If a single stage Haar wavelet transform is used in data compression then a wavelet coefficient satisfying Inequality 1 corresponds to a two by two block in the original image frame In. For example, (x,y)-th coefficient of the sub-band image HDₙ (1) (or other sub-band images HVₙ (1) , HHₙ (1) , LLₙ (1) ) of the current image Iₙ satisfies Inequality I then this means that there exists motion in a two pixel by two pixel region in the original image, Iₙ (k,m), k=2x, 2 x−1, m=2 y, 2 y−1 because of the sub-sampling operation in the discrete wavelet transform computation. Similarly, if the (x,y)-th coefficient of the sub-band image HDₙ (2) (or other second scale sub-band images HVₙ (2) , HHₙ (2), LLₙ (2) ) satisfies Inequality 1 then this means that there exists motion in a four pixel by four pixel region in the original image, Iₙ (k,m), k=2x, 2x−1, 2x+1, and m=2 y, 2y−1, 2y+1. In general a change in the 1-th level wavelet coefficient corresponds to a 2¹ by 2¹ region in the original image.

In other wavelet transforms the number of pixels forming a wavelet coefficient is larger than four but most of the contribution comes from the immediate neighborhood of the pixel (k,m)=(2x, 2y) in the first level wavelet decomposition, and (k,m)=(2¹x, 2¹y) in 1-th level wavelet decomposition, respectively. Therefore, in other wavelet transforms we classify the immediate neighborhood of (2x,2y) in a single stage wavelet decomposition or in general (2¹x, 2¹ y) in 1-th level wavelet decomposition as a moving region in the current image frame, respectively.

Once all wavelet coefficients satisfying Inequality 1 are determined the union of the corresponding regions on the original image is obtained to locate the moving object(s) in the video. The number of moving regions or objects is equal to the number of disjoint regions obtained as a result of the union operation. The size of the moving object(s) is (are) estimated from the union of the image regions producing the wavelet coefficients satisfying Inequality 1.

The above wavelet frame differencing approach usually determines larger regions than actual moving regions. This is because a moving region reveals also a portion of the background scene in the current image Iₙ whose pixel values are different from the pixel values of the corresponding region in Iₙ₋₁. As a result wavelet coefficients of these regions are also different from each other and they satisfy Inequality 1. In order to solve this problem the wavelet transform of the background can be estimated from the wavelet transforms of past image frames. The wavelet transform of the background scene can be estimated from the wavelet coefficients which do not change in time. Stationary wavelet coefficients are the wavelet coefficients of background scene because background can be defined as temporally stationary portion of the video. If the scene is observed for some time then the wavelet transform of the entire background scene can be estimated because moving regions and objects occupy only some parts of the scene in a typical image of a video. In this approach comparator block 20 of FIG. 3 has a memory to estimate the wavelet transform of the background. A simple approach to estimate the wavelet transform of the background is to average the observed wavelet transforms of the image frames. Since moving objects and regions occupy only a part of the image and they reveal a part of the background scene their effect in the wavelet domain is cancelled over time by averaging.

More sophisticated approaches were reported in the literature for estimating the background scene. Any one of these approaches can be implemented in wavelet domain to estimate the DWT of the background from the DWT of image frames without performing inverse wavelet transform operation. For example, in the article “A System for Video Surveillance and Monitoring,” in Proc. American Nuclear Society (ANS) Eighth International Topical Meeting on Robotics and Remote Systems, Pittsburgh, Pa, Apr. 25-29, 1999 by Collins, Lipton and Kanade, a recursive background estimation method was reported from the actual image data. This method can be implemented in wavelet domain as follows:
WBₙ₊₁ (x,y)=aWBₙ (x,y)+(1−a) WIₙ (x,y), if WIₙ (x,y) is not moving
WBₙ₊₁ (x,y)=WBₙ (x,y), if WIₙ (x,y) is moving
where WBₙ is an estimate of the DWT of the background scene, the update parameter a is a positive number close to 1. Initial wavelet transform of the background can be assumed to be the wavelet transform of the first image of the video. A wavelet coefficient WIₙ (x,y) is assumed to be moving if
|WIₙ (x,y)−WIₙ₋₁(x,y)|>Tₙ(x,y)
where Tₙ (x,y) is a threshold recursively updated for each wavelet coefficient as follows
Tₙ₊₁ (x,y)=aTₙ (x,y)+(1−a) (b|WIₙ (x,y)−WBₙ (x,y)|, if WIₙ (x,y) is not moving
Tₙ₊₁ (x,y)=Tₙ (x,y), if WIₙ (x,y) is moving
where b is a number greater than 1 and the update parameter a is a positive number close to 1. Initial threshold values can be experimentally determined. As it can be seen from the above equation higher the parameter b higher the threshold or lower the sensitivity of detection scheme.

Estimated DWT of the background is subtracted from the DWT of the current image of the video to detect the moving wavelet coefficients and consequently moving objects as it is assumed that the regions different from the background are the moving regions. In other words all of the wavelet coefficients satisfying the inequality
|WIₙ (x,y)−WBₙ(x,y)|>Tₙ(x,y) Inequality 2
are determined. Once these wavelet coefficients satisfying the above inequality are obtained, the corresponding regions on the original image are determined 26 as described above. This approach based on estimating the DWT of the background produces more accurate results than the wavelet frame differencing approach which usually determines larger regions than actual moving regions.

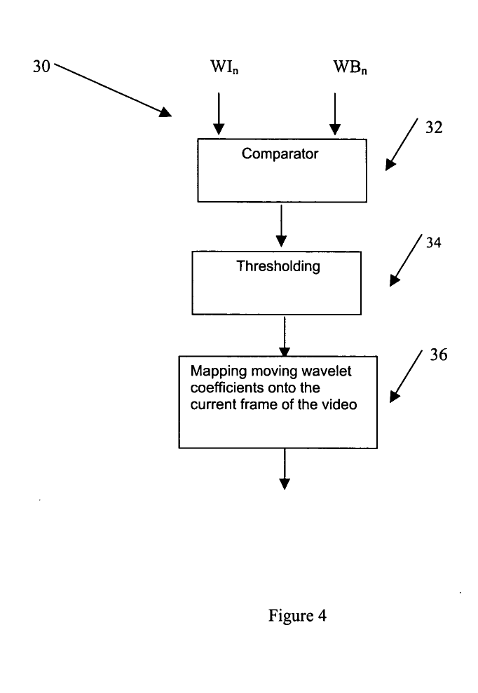

FIG. 4 is a block diagram 30 illustrating the background estimation based moving object detection method by comparing the wavelet transform of the current image with the estimated wavelet transform of the background. The wavelet transform of the current image WIₙ and the estimated wavelet transform of the background scene WBₙ are input to a comparator 32. The comparator 32 may simply take the difference of WIₙ and WBₙ to determine if there is a change in wavelet coefficients. The output of the comparator 32 is processed by a thresholding block 34 performing Inequality 2 for each wavelet coefficient. Once all the wavelet coefficients satisfying the above inequality are determined, locations of corresponding regions on the original image are determined 36.

Although the present invention has been described in accordance with the embodiments shown, one of ordinary skill in the art will readily recognize that there could be variations to the embodiments and those variations would be within the spirit and scope of the present invention. For example, although the present invention is described in the context of a frame being divided into four quadrants, or quarters, or sub-images in each level of wavelet decomposition one of ordinary skill in the art recognizes that a frame could be divided into any number of sub-sections and still be within the spirit and scope of the present invention. Accordingly, many modifications may be made by one of ordinary skill in the art without departing from the spirit and scope of the appended claims.

1. A method for detecting moving objects and regions in video compressed by a wavelet transform, the method comprising:
comparing the wavelet transform of a current image frame and the wavelet transform of a previous image frame of the video; wherein a difference between the wavelet coefficients of the current and previous image frames indicate the existence of the motion of the moving objects and regions, wherein an inverse wavelet transformation is not performed.

2. The method of claim 1 wherein locations of moving objects and regions on the current image of the video are estimated by determining the indices of image pixels of the video producing the wavelet coefficients of the current image frame differing from the corresponding wavelet coefficients of the previous image.

3. The method of claim 1, wherein the comparing step includes matching a predetermined area in the wavelet transform of one image with a predetermined area in the wavelet transform of the next image by shifting as one unit in a wavelet domain; calculating a difference of wavelet coefficient values between the predetermined area in the wavelet transform of the one image and each matched area of the wavelet transform of the next image; and calculating an evaluation value of the difference of the wavelet coefficient values, wherein if this evaluation value is above a threshold then there is motion.

4. The method of claim 1 wherein the locations of moving object and regions on the current image of the video are estimated by determining the indices of image pixels of the video producing the wavelet coefficients of a current image frame differing from the wavelet coefficients of previous image frames, wherein given the wavelet coefficients it is possible to determine the location of pixel values on the current image frame producing the wavelet coefficient.

5. A method for estimating the moving objects and regions of a video, the method comprising:
comparing a wavelet transform of a current image of the video with an estimated wavelet transform of a background scene which does not contain moving objects and regions, wherein the motion or the presence or absence of the moving objects and regions in the current image frame of the video is determined without performing an inverse wavelet transformation operation.

6. The method of claim 5, wherein the wavelet transform of the background scene is estimated from the wavelet transforms of past image frames of the video, wherein wavelet coefficients whose value do not change or change below a threshold over time in plurality of images forming the video are classified as wavelet coefficients of the background scene.

7. The method of claim 5, wherein the locations of moving regions on the current image of the video are estimated by determining the indices of the image pixels producing the wavelet coefficients of the current image frame differing from the wavelet coefficients of the estimated background.

8. The method of claim 5, wherein the comparing step comprises:
matching a predetermined area in the wavelet transform of one image with the predetermined area in the estimated wavelet transform of the background image by shifting as one unit in the wavelet domain;
calculating the difference of wavelet coefficient values between the predetermined area in the wavelet transform of the one image and each matched area of the estimated wavelet transform of the background image, and
calculating an evaluation value of the difference of the wavelet coefficient value.

9. The method of claim 6 wherein the threshold for determining the moving wavelet coefficients is estimated in a recursive manner from the threshold value used in previous comparison, and difference of the previous value of the wavelet coefficient and estimated wavelet coefficient of the background.

10. A system for detecting moving objects and regions in video compressed by a wavelet transform, the system comprising:
a comparator mechanism for comparing the wavelet transform of a current image frame and the wavelet transform of a previous image frame of the video;
a mapping mechanism for utilizing a difference between the wavelet coefficient of the current and previous image frames to indicate the motion, wherein an inverse wavelet transform is not performed.

11. The system of claim 10 wherein locations of moving objects and regions on the current image of the video are estimated by determining the indices of image pixels of the video producing the wavelet coefficients of the current image frame differing from the corresponding wavelet coefficients of the previous image.

12. The system of claim 10 wherein the comparator mechanism comprises:
means for matching a predetermined area in the wavelet transform of one image with a predetermined area in the wavelet transform of a next image by shifting as one unit in a wavelet domain;
means for calculating a difference of wavelet coefficient values between the predetermined area in a wavelet transform of the one image and each matched area of a wavelet transform of the next image; and
means for calculating an evaluation value of the difference of the wavelet coefficient values wherein if the evaluation value is above a threshold then there is motion.

13. The system of claim 10 wherein the locations of moving object and regions on the current image of the video are estimated by determining the indices of image pixels of the video producing the wavelet coefficients of a current image frame differing from the wavelet coefficients of previous image frames, wherein given the wavelet coefficients it is possible to determine the location of pixel values on the current image frame producing the wavelet coefficient.

14. A system for estimating the moving objects and regions of a video; the system comprising:
a comparator for comparing a wavelet transform of a current image frame of the video with an estimated wavelet transform of a background scene which does not contain moving objects and regions; and
means for determining whether a motion or the presence or absence of the moving object and regions is within the current image frame without performing an inverse wavelet transformation operation.

15. The system of claim 14, wherein the wavelet transform of the background scene is estimated from the wavelet transforms of past image frames of the video, wherein wavelet coefficients whose value do not change or change below a threshold over time in plurality of images forming the video are classified as wavelet coefficients of the background scene.

16. The system of claim 5, wherein the locations of moving regions on the current image of the video are estimated by determining the indices of the image pixels producing the wavelet coefficients of the current image frame differing from the wavelet coefficients of the estimated background.

17. The system of claim 14 wherein the comparator comprises:
means for matching a predetermined area in the wavelet transform of one image with a predetermined area in the estimated wavelet transform of the background image by shifting as one unit in the wavelet domain;
means for calculating the difference of wavelet coefficient values between a predetermined error in the wavelet transformation of the one image and each matched area of the estimated wavelet transform of the background image; and
means for calculating an evaluation value of the difference of the wavelet coefficient values.

18. The system of claim 15 wherein the threshold for determining the moving wavelet coefficients is estimated in a recursive manner from the threshold value used in previous comparison, and difference of the previous value of the wavelet coefficient and estimated wavelet coefficient of the background.

19. A computer readable medium containing program instructions for detecting moving objects and regions in video compressed by a wavelet transform, the program instructions for:
comparing the wavelet transform of a current image frame and the wavelet transform of a previous image frame of the video; wherein a difference between the wavelet coefficients of the current and previous image frames indicate the existence of the motion of the moving objects and regions, wherein an inverse wavelet transformation is not performed.

20. The computer readable medium of claim 19 wherein locations of moving objects and regions on the current image of the video are estimated by determining the indices of image pixels of the video producing the wavelet coefficients of the current image frame differing from the corresponding wavelet coefficients of the previous image.

21. The computer readable medium of claim 19, wherein the comparing step includes matching a predetermined area in the wavelet transform of one image with a predetermined area in the wavelet transform of the next image by shifting as one unit in a wavelet domain; calculating a difference of wavelet coefficient values between the predetermined area in the wavelet transform of the one image and each matched area of the wavelet transform of the next image; and calculating an evaluation value of the difference of the wavelet coefficient values, wherein if this evaluation value is above a threshold then there is motion.

22. The computer readable medium of claim 19 wherein the locations of moving object and regions on the current image of the video are estimated by determining the indices of image pixels of the video producing the wavelet coefficients of a current image frame differing from the wavelet coefficients of previous image frames, wherein given the wavelet coefficients it is possible to determine the location of pixel values on the current image frame producing the wavelet coefficient.

23. A computer readable medium containing program instructions for estimating the moving objects and regions of a video, the program instructions for:
comparing a wavelet transform of a current image of the video with an estimated wavelet transform of a background scene which does not contain moving objects and regions, wherein the motion or the presence or absence of the moving objects and regions in the current image frame of the video is determined without performing an inverse wavelet transformation operation.

24. The computer readable medium of claim 23, wherein the wavelet transform of the background scene is estimated from the wavelet transforms of past image frames of the video, wherein wavelet coefficients whose value do not change or change below a threshold over time in plurality of images forming the video are classified as wavelet coefficients of the background scene.

25. The computer readable medium of claim 23, wherein the locations of moving regions on the current image of the video are estimated by determining the indices of the image pixels producing the wavelet coefficients of the current image frame differing from the wavelet coefficients of the estimated background.

26. The computer readable medium of claim 23, wherein the comparing step comprises:
matching a predetermined area in the wavelet transform of one image with the predetermined area in the estimated wavelet transform of the background image by shifting as one unit in the wavelet domain;
calculating the difference of wavelet coefficient values between the predetermined area in the wavelet transform of the one image and each matched area of the estimated wavelet transform of the background image, and
calculating an evaluation value of the difference of the wavelet coefficient value.

27. The computer readable medium of claim 24 wherein the threshold for determining the moving wavelet coefficients is estimated in a recursive manner from the threshold value used in previous comparison, and difference of the previous value of the wavelet coefficient and estimated wavelet coefficient of the background.
